(19) United States
(12) Patent Application Publication
(10) Pub. No.: US 2003/0131061 A1
(43) Pub. Date: Jul. 10, 2003

(54) Transparent proxy server for instant messaging system and methods

(75) Inventors: Michael O. Newton, Los Altos, CA (US); Adam Fritzler, Emeryville, CA (US); Timothy Kay, Los Altos, CA (US)

Correspondence Address: DARBY & DARBY P.C., Post Office Box 5257, New York, NY, 10150-5257, US

(73) Assignee: Active Buddy, Inc.

(21) Appl. No.: 10/306,717

(22) Filed: Nov. 27, 2002

Related U.S. Application Data
(60) Provisional application No. 60/333,904, filed on Nov. 28, 2001.

(51) Int. Cl. G06F 15/16

(52) U.S. Cl. 709/206; 709/203

(57) ABSTRACT

A proxy server connected to a local network. The proxy server receives an instant message which was sent from a first-end user who is also connected to the local network. This message is associated with an instant messaging service which, in turn, is supported supported by a back-end instant messaging server. The proxy server determines whether the second end-user, to whom the message is intended, is connected to the local network. In the event that the second end-user is connected to the local network, the proxy server directs the instant message to the second end-user solely within the local network while bypassing the remote network and the instant messaging server. Also disclosed is a method for enhancing instant messaging functionality using a proxy server.

This patent application claims the benefit of priority under 35 U.S.C. 119(e) from U.S. provisional application 60/333,904 filed Nov. 28, 2001, entitled “Transparent Proxy Server For Instant Messaging System And Methods” the entirety of which is hereby incorporated by reference.

### BACKGROUND OF THE INVENTION

An instant messaging (IM) system consists of two components: client software (also referred to as client IM software) and a back-end service. In a typical operation of the system, the client software runs on many end-user workstations. Each copy of the client software requests from its user an account and password, which it sends over a network 101 to a service 102. The service validates the information, and then allows that copy of the client software authenticated access to the service.

Once authenticated, the client software enables its end user to access the features of that IM service, including, but not limited to, the storage and retrieval of a user list, status information for users on the user list, and the ability to send and receive instant messages to other users.

Authenticated users can add each other to their respective user lists, see indications as to the status of the other users (such as available, away, idle, offline), and can send each other instant messages. A user sends an instant message by indicating such desire to the client software and indicating which other user (or users, in the case of multiparty chat) is to receive the message, perhaps by clicking on other users' names in the user list. The user thus causes to be created a special messaging window, in which he composes a message and hits send. The message is sent over the network to the IM service, which then communicates the message to the other users' client software. The other users then see their own messaging window, which contains the message sent by the first user.

All users can then send instant messages to each other. The client software sends each message over the network to the IM service, which then sends the message to the other client software to be displayed in the messaging window.

There is a mode, called direct-connect mode, in which the client software talks directly over the network to another client software, without having to send each message through the IM service. In direct-connect mode, a connection is created from one instance of the client software, directly to another instance of the client software. In order for direct-connect mode to be established, at least one of the end-users' client software must be able to receive incoming network connections. Therefore, direct-connect mode does not work between a particular pair of users, when both of those users' workstations are behind firewalls which typically prevent all incoming connections.

The typical operation of an IM system exposes a serious security flaw. With the exception of direct-connect mode, messages between each pair of users pass through the IM service. Therefore, the text of any conversation can be monitored by the people running the service, or their communications providers. Individual users might rely on the anonymity a large number of users brings, but enterprises cannot afford to trust the fact that their conversations will be ignored, simply because they represent a few conversations among many. To enterprises, it is never acceptable that sensitive internal (e.g., employee-to-employee) conversations go through another enterprises' servers unprotected in any way.

The term enterprise refers to a corporation or similar organization that uses a computer network.

And, ironically, the enterprises are the ones for which the security of direct-connect mode is the least likely to be available, as security-minded enterprises are likely to use firewalls. In fact, two end users sitting in adjacent cubicles and both behind the same firewall, often cannot use direct-connect mode (even if it is supported by the IM service in question). In the typical operation of an IM system, their conversation goes through the servers of the IM service, whose operators (or connectivity providers) could snoop on these internal conversations if that enterprise (the enterprise running the IM service) or the operators themselves so desired.

Another typical limitation of instant messaging systems is that many enterprises require that various classes of communications be logged. The financial industry, for example, has the requirement that all internal communication be logged. More generally, many enterprises require that all communication with external parties be logged.

### SUMMARY OF THE INVENTION

In one aspect, the present invention provides a method for directing an instant message to an end user using an instant messaging protocol. The method in accordance with this aspect of the invention provides a proxy server onto a local network. The proxy server receives an instant message which was sent from a first-end user who is also connected to the local network. This message is associated with an instant messaging service which, in turn, is supported supported by a back-end instant messaging server. The proxy server determines whether the second end-user, to whom the message is intended, is connected to the local network. In the event that the second end-user is connected to the local network, the proxy server directs the instant message to the second end-user solely within the local network while bypassing the remote network and the instant messaging server.

In another aspect of this method, in the event that the second user is not connected to the local network, the instant message is forwarded to the second end-user by way of back end instant messaging server.

In another aspect a method for enhancing the instant messaging functionality is provided for an end user using an instant messaging software application that is configured to interact with a back-end instant messaging server. The method consists in providing a proxy server and “inserting” this server in the communication channel between the application and the back-end server, by creating a network connection between the application and the proxy server, and another network connection between the proxy server and the back-end server. The proxy server is transparent to the instant messaging application, which implies that the instant messaging software application does not need to be changed in order to connect to the proxy server. The computer on which this application is implemented on does not need to be changed either. Once the proxy server is connected as described, it selectively directs messages between the instant messaging application and the back end internet server.

The proxy server can be a hardware server or a software server application, depending on the particular implementation.

These and other aspects and features and advantages of the present invention can be appreciated from the accompanying drawing Figures and detailed description of certain preffered embodiments.

### BRIEF DESCRIPTION OF THE DRAWINGS

FIG. 1 is a block diagram of an IM environment containing two enterprises, several users, several TPSs and one IM service.

FIG. 2 is a flow chart showing the way the TPS executes short circuiting;

FIG. 3 is a detailed block diagram of an IM environment.

FIG. 4 is a flow chart showing the operation of an enterprise DNS;

FIG. 5 is a block diagram showing an enterprise with multiple TPSs;

FIG. 6 is a flow chart, showing the TPS routing process;

FIG. 7 is a block diagram showing peering and routing between two TPSs in two enterprises;

FIG. 8 is a block diagram of several TPSs which are peered in a way that requires indirect routing;

### DETAILED DESCRIPTION OF THE PREFERRED EMBODIMENTS

Our invention adds an additional component, called a transparent proxy server, or TPS, to the conventional IM system. Preferably the TPS is placed within the enterprise firewall. Alternatively, the TPS can be placed outside the enterprise firewall. The TPS is called “transparent” because it is designed to appear to the client IM software as an exact replacement for the back-end service.

Many advantages are gained by inserting the TPS between the client IM software and the back-end service, such as improved security, logging, and others discussed below.

In one of its aspects, the invention operates to short circuit a normal data flow between users logged into a messaging service. In other words, the data does not travel to a back-end server through the Internet or other public network. Nevertheless, the presence of all users is logged onto the instant messaging service, so users within a domain using a transparent proxy server can communicate with each other in a secure manner within their local domain while simultaneously maintaining a communication with users in other domains through the public network. Moreover, advertisements and global messages to all logged in users can still be communicated to all users by the messaging service.

The TPS can be used to implement other useful features, such as administrator control over IM usage within the enterprise, sending automatic control messages to users, allowing users to effortlessly use one messaging client to message people that are logged in other networks, allowing more user-friendly screen names and allowing administrators to control the versions of the client IM software used by the users.

Furthermore, several TPSs may be used by an enterprise, in order to allow for scalability and redundancy. Also, TPSs from different enterprises may be connected in order to provide the above listed features for communications accross those enterprises.

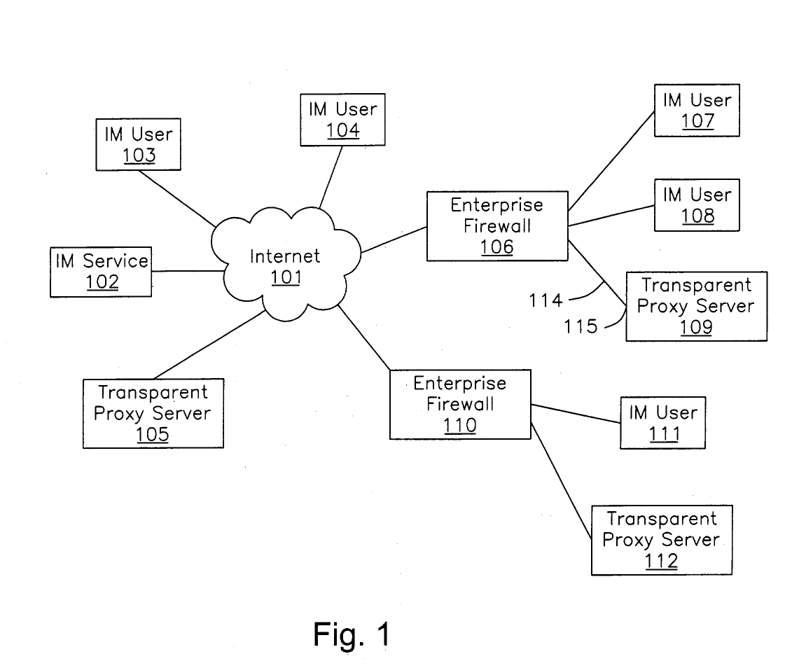

FIG. 1 is a block diagram of an environment containing several IM users (sometimes reffered to as “end users”), some of which use proxy servers to connect to the IM service 102, and some of which do not. IM users 107, 108, and 111 are using computers that are part of enterprise networks and which are connected behind enterprise firewalls. Transparent proxy servers 109 and 112 are examples of TPSs that are located behind enterprise firewalls. Transparent proxy server 105 is an example of a TPS that can be connected outside of a firewall. Transparent proxy server 105 may serve an enterprise not shown, one of the two enterprises that are shown, or individual IM users.

When in operation, a transparent proxy server that is located withing the enterprise firewall 109 can maintain several connections 114 with the local network, such as a connection to one or more of the local IM users 107, 108 and a connection to the back end server 102. These connections are serviced by software routines that are reffered to as ports 115.

When two end users communicate with each other, messages are typically sent from one copy of the client IM software 309, to the back-end server 102, on to the other copy of the client IM software 311. If both copies of the client IM software are interacting with the TPS, as would be the case with enterprise users 107 and 108, then the TPS can short circuit traffic between them as discussed below.

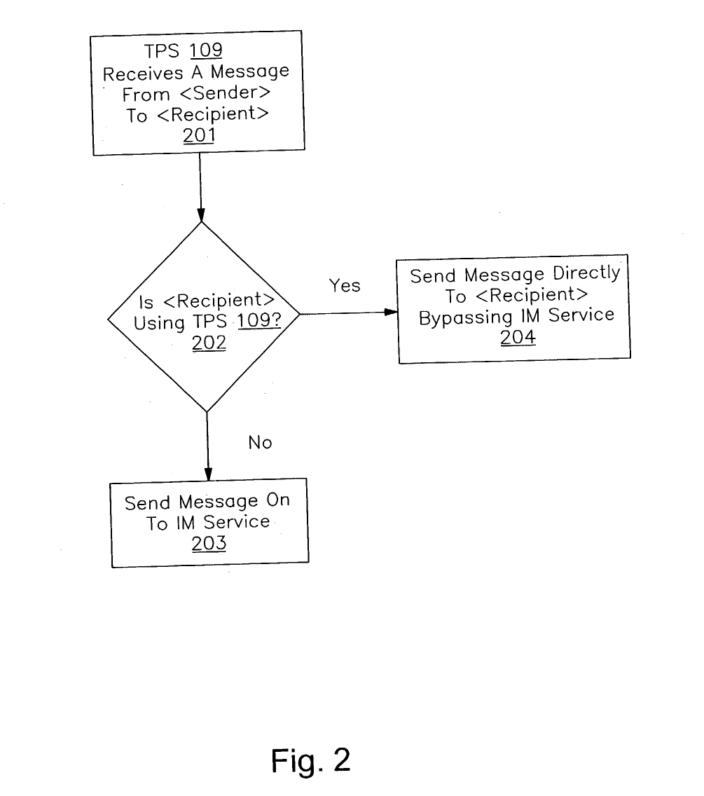

FIG. 2 illustrates the decision making process employed by the TPS in a preferred embodiment. Whenever a message is received by the TPS 109 from a subscribed user as shown at step 201, the target of the message can be evaluated at step 202. If that target user is also a subscriber to the same TPS, then the message is sent directly to the target, bypassing the back-end service altogether (step 204). Otherwise the message is sent to the IM service 2 at step 203.

By short circuiting traffic between users 107 and 108, the TPS 9 facilitates the communciation, while preventing the messages from passing outside the enterprise firewall 106. Thus the communication between enterprise users is secure. Moreover, users 107 and 108 are present on the IM service (if authenticated after login) without burdening that service with messages between them.

The TPS sees all traffic from and to its subscribed users. It is therefore able to log such traffic. There are two kinds of logging that the TPS can perform: adminstrative logging and user logging.

Administrative logging exists so that the enterprise can keep track of communication performed by the employee end users on behalf of the enterprise through the EM service. The TPS records all communications that it facilitates. Optionally, the TPS is set to record the date and time that a communication occurred with or without the actual text of the communication session.

User logging exists for the convenience of the subscribed users. Some users like to keep copies of all the email they send and receive. Correspondingly, some users like to keep track of all the IM sessions in which they participate. On a user-by-user basis, the TPS can be configured to record the text of each IM session. Those sessions can then be archived for the user, or delivered to the user via one of several mechanisms.

One preferred mechanism for delivering the text of IM sessions is to use email. The user creates a profile, as described below. The profile contains the user's email address as well as the user's preferences about the sending of user logs. The user can specify that all logs are to be sent. The user can also enter a list of screen names for which logs are not to be sent. Alternatively, the user can specify that logs are not to be sent for any users except those explicitely specified. Finally, as described below in “Commands,” the user can indicate on a per session basis, which session logs are to be sent or not sent.

Via one of several mechanisms, depending on network configuration and administrative choice, the client IM software is caused to interact with (subscribe to) the TPS rather than directly to the IM system's back-end service. The client IM software will (either knowingly or unknowningly) interact with the TPS, and the TPS will then interact with the back-end service on the client IM software's behalf.

Preferably the client IM software will be made to interact with the TPS in a manner that doesn't require changes to the client IM software configuration nor to the workstation configuration. A preferred mechanism is to change the behavior of the DNS server, so that, when it asks for it, the client IM software receives the IP address of the TPS rather than the address of the back-end service. If the administrator controls the DNS servers that are used by the workstations, then one or more IP addresses may by modified, so that the client IM software interacts with the TPS while thinking it is interacting with the back-end system, that is, unconcerend with the rerouting achieved by the TPS.

For example, the client IM software of the AOL Instant Messenger (AIM) system is configured by default to interact with the back-end system using domain name login.oscar.aol.com. By modifying the enterprise DNS servers, so that a query for login.oscar.aol.com resolves to the IP address of the TPS rather than the real IP address of the AOL server, the client IM software can be made to interact with the TPS instead.

If the enterprise DNS server does not allow for the substitution of one name for another, then a new DNS server can be introduced that performs specifically the one action of changing the IP address of a specific few hosts. For all other requests, this new DNS server would recurse to the original enterprise DNS servers. In an embodiment, the new DNS server and the TPS are the same server.

Another mechanism for forcing the client IM software to subscribe to the TPS is to shunt the relevant network traffic directly to the TPS. There are off-the-shelf appliances and software systems that can do the shunting either by IP address or by port number. For example, load balancers from Foundry Networks can do the shunting, as can the firewall component of the Linux operating system. As a last resort, or for testing, many implementations of client IM software can be individually configured (either manually or automatically) via a configuration mechanism, so that the software will interact with the TPS rather than the back-end service.

The method of changing the behavior of the DNS server is described below in more detail.

Before a certain computer can initiate network communication with another computer, the first computer needs to have the network address, typically the IP address, of the second computer. Often the first computer only possesses the host name of the second computer. The reason for that is that host names are easier for humans to remember, so people are usually only able to enter a host name into a computer. Thus the first computer must rely on a name service (NS) that converts a host name into the network address of the computer, which is associated with that host name. This retrieval of network address corresponding to a host name is sometimes referred to as mapping a host name to network address.

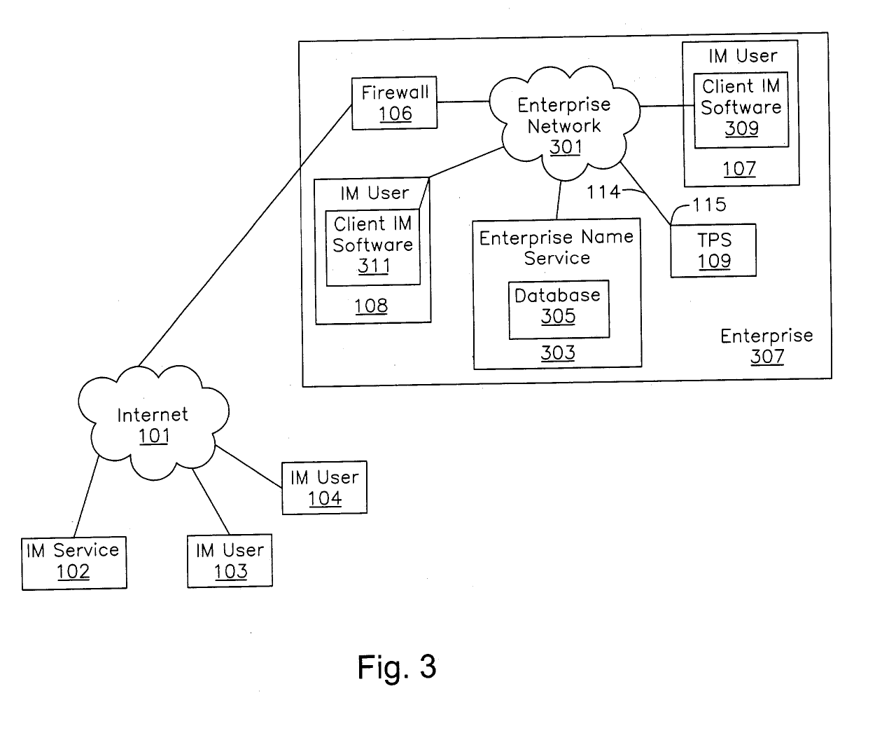

FIG. 3 shows an enterprise 307 which runs its own name service—the enterprise name service 303. An enterprise name service may be implemented on one or more computers, each known as a name server. The enterprise name service 303 can match up host names with IP addresses only for computers that are within the enterprise 307 that are connected to the enterprise local network 301, and it needs to consult other name services for computers outside of the enterprise 307. The enterprise name service 303 usually includes a database 305 of the host names and IP addresses of all the networked computers within the enterprise. If a particular host name is listed in the database 305, then the enterprise name service 303 is authoritive for that host name and the computer that corresponds to it.

Computers in the enterprise, which need to make use of the enterprise name service 303, are statically configured with the IP address of the enterprise name service or learn the network address of the enterprise name service dynamically via DHCP or some other well defined protocol. When a computer within the enterprise 307 needs to use a name service, it consults the enterprise name service 303.

If the enterprise name service 303 receives a request for network address, which corresponds to a host name that is not in the database, it will make a request to other name services, outside the enterprise. This process of forwarding a name service request on to other name services is called recursing.

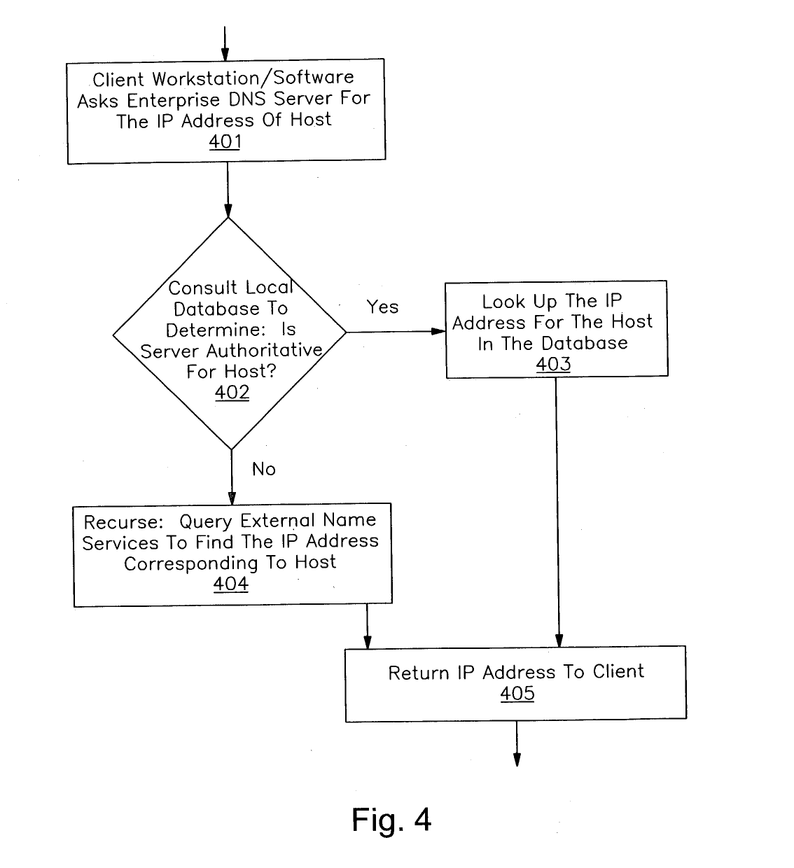

At step 401 of FIG. 4 a client computer makes a request to its enterprise name service to map a host name to its corresponding network address. The request is sent to the enterprise name service 303. At step 402, the enterprise name service determines if it is authoritative for the requested host name. It makes the determination by consulting its database 305. Under normal use, the enterprise name service 303 is never authoritative for IM service host names (except in the rare case when the client IM software is in the same enterprise as the IM service). If the host name is found in that database, then at step 403 the enterprise name service finds the network address that corresponds to that host name. Finally, at step 405, that IP address is returned to the client computer 107, 108, etc. that requested it.

On the other hand, if, at step 402, the enterprise name service 303 determines that it is not authoritative for the requested host name, then, at step 404, the enterprise name service recurses—i.e. forwards the request to another name service, such as the Internet DNS system, in order to determine the needed network address. Finally, at step 405, the thus determined network address is returned to the client computer.

The client IM software (running on the computer of IM user 107, 108, etc.) is usually configured to initiate a direct connection to the IM service 102. Embodiments of this invention direct the client IM software to communicate with the TPS 109 rather than the IM service 102. Rather than change the client IM software for that purpose, it is preferred to change the way that the enterprise name service 303 works.

When the client IM software of, for example, IM user 107 starts, one of its first tasks is to make a network connection to the IM service 102. The host name of the IM service 102 is known to the client IM software. The client IM software makes a request to the name service 303 in order to receive the network address that corresponds to the IM service 102 host name. Once the network address is determined, the client IM software makes a network connection to that IM service.

To insert the TPS 109 into the IM traffic within the enterprise, a change is made to the enterprise name service. Normally the enterprise name service 303 is not authoritative for IM service host names, which is a consequence of the fact that the IM service 102 is not part of the enterprise 307. Since the IM service 102 is not a part of the enterprise 307, the enterprise name service 303 does not have the hostname and network address information of the IM service 102. To insert the TPS, the IM service hostname is added to the enterprise name service database 305, and is made in that database, to correspond to the network address of the TPS 109 instead of that of the IM service 2.

The process of adding entries to the database 305 is determined by the particular name service software used by the enterprise 307. For some software, the name-service administrator must interact with the name-service software's user interface to define additional host names and network addresses for which the name-service is to be authoritative. For other software, a collection of text files defines the database and the creation of a text file that contains the host names and network addresses will cause the enterprise name service to be authoritative for the IM service host names.

It is key that when adding an entry for the IM service 102 to the database 305, the network address of the TPS 109 is used. The behavior of the enterprise name service is thus modified, so that it gives the “wrong” answer when asked about the network address that truly corresponds to IM service host name.

Let us consider FIG. 4 in the context of a modified enterprise name service. At step 401, the client IM software makes a request to the enterprise name service 303 for the IP address that corresponds to IM service 102. Step 402 determines whether the enterprise name service is authoritive for the IM service's host name. Under normal circumstances, when no TPS is in use, the answer would be “no”. However when the TPS is in use, the enterprise name service has been modified to be authoritative for IM service's host names, so the answer is now “yes”. The network address corresponding to the IM service's host name is retrieved from the database 305. This retrieved network address, however, is not the network address of the IM service 102, but instead the network address of the TPS 109 is substituted in its place.

With the modified enterprise name service, IM users 107, 108, etc. make this initial network connection to the TPS 109 rather than to the IM service 102. This can be done without any need to modify the client IM software.

Thus, the TPS 109 inserts itself between the client IM software 309, 311 and the IM service 102. The client IM software 309, 311 behaves as if it is connecting directly with the IM service 102. The IM service 102 also behaves as if it is directly connected to the client IM software 309 or 311. When an IM user 107 (with client IM software 309) connects to the TPS 109, the TPS 109 opens a corresponding connection to the IM service 102. The TPS 109 then selectively forwards requests from the IM user 107 to the IM service 102 and requests from the IM service 102 to the IM user 107.

Positioned in the middle of the client-server conversation, the TPS 109 can behave passively, forwarding all messages between the IM user 107 and the IM service 102. In a passive capacity, the TPS 109 can have useful features, such as logging and auditing.

The TPS 109 can also have useful features that require active behavior. Active behavior is behavior in which the TPS 109 somehow changes the communication between the IM client and the IM service. One particularly useful feature that requires active behavior is short circuiting in which messages between IM service users are selectively passed trough the IM service 102. As FIG. 2 illustrates, at step 201, a message from the client IM software, associated with screen name <Sender>, arrives at the TPS. The message specifies the target screen name <Recipient>.

There are two relevant possibilities regarding the relationship between the screen name <Recipient> and the TPS. One possibility is that a copy of the client IM software, associated with screen name <Recipient>, is connected to the IM service via the TPS 9. An example of this possibility is IM user 107 being <sender> and IM user 108 is <Recipient>. The other is that none of the client IM software connections to the TPS 109 is associated with screen name <Recipient>. An example of this possibility is IM user 107 being <Sender> and IM user 104 being <Recipient>. This second possibility includes the scenarios where <Recipient> is logged in directly to the IM service, that <Recipient> is logged in via another TPS or another proxy server altogether, or that <Recipient> is not logged in at all.

At step 202 of FIG. 2, the TPS 109 determines whether the client IM software associated with screen name <Recepient> is connected to the TPS 109 or not. If it is not, then, at step 203, the TPS 109 continues its passive role and forwards the message to the IM service, namely, to complete the communication session through the IM service 2 as is conventional. If <Recipient> is connected to the TPS 109, then at step 204, rather than forwarding the message to the IM service, the TPS 109 sends the message directly to the client IM software associated with screen name <Recipient>. This is referred to as “short-circuiting”.

As has been described, a TPS provides an enterprise with additional capabilities (such as security, control, logging, and auditing) beyond those offered by the public IM services. With the benefits of a TPS, however, come potential problems.

An enterprise may be large enough to create more IM traffic than a TPS can satisfactorily handle. If too many IM clients connect to the IM service through the TPS, then IM performance for the entire enterprise will degrade.

Another potential problem is that a TPS may fail. Such a failure could be due to any number of factors, such as a hardware failure, a software failure, or a power failure. When a TPS fails, IM users inside the enterprise, served by the TPS, lose their access to the IM service.

The preferred solution to both of the above problems is to deploy a plurality of TPSs to serve the enterprise cooperatively. In the case that the enterprise is too large for a single TPS, additional servers will be deployed. The ability of a system to run additional components to handle a larger load is called scalability.

In the case that server availability in the face of various failure modes is important, the enterprise can deploy two (or more) TPSs. The ability of a system to run additional components to prevent reduce the impact of failures is called redundancy.

In the case that it requires both scalability and redundancy, the enterprise can deploy N+1 (or more) TPSs, where N is the number of TPS needed to serve all the users in the enterprise. If one TPS out of N+1 (or more)were to fail, then at least N TPSs would still survive, providing adequate capacity for all employees.

When more than one TPS exist in the enterprise, the issue arises as to which TPS the IM client on a given workstation should connect. There are several known practices for making such assignments when a collection of similar servers is deployed. The simplest is called round-robin name service, in which the enterprise name service is given the collection of network addresses for a given host name (e.g., login.oscar.aol.com), in which case the NS service provides a successive IP address from the collection to each workstation on a round-robin basis. Alternatively, the TPSs could be placed behind standard load balancing equipment, which would then make the assignments using round-robin assingment, load balancing, or several other choices offered by such equipment.

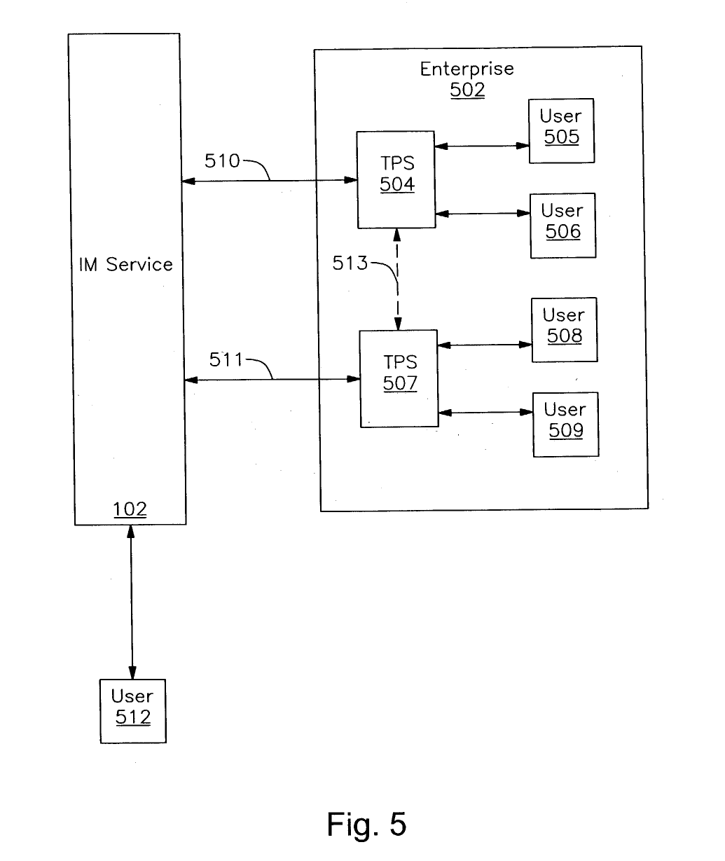

An enterprise, having deployed a plurality of TPSs, is configured as illustrated by FIG. 5. The m users (505, 506, 508, 509) are connected to N TPSs (504, 507). The assignment between users and TPSs is arbitrary, with a roughly equal number of users connected to each TPS. The TPSs in turn are connected to the IM service 102.

In the default case, each TPS knows only of its connected users and the IM service. If one of the connected users 505 sends a message to another user 506, connected to the same TPS, then the TPS will short circuit the message, as has been previously described, and the message avoids traversing the Internet and the IM service in clear text.

If a user 505, sends a message to a user 512 that is not behind the enterprise TPS (although user 512 might be behind the TPS of an unrelated enterprise), then the message will travel transparently through the TPS, be delivered to the IM service 102, which in turn forwards the message to user 512. In this case the message traverses the Internet and the IM service 102 in clear text. This case is acceptable, as the IM service is the only link between users 505 and 512. It is for the enterprise to decide if the benefit in sending such messages outweighs the security risks.

When a user connected to one TPS (for example 504) wishes to talk to a user connected to another TPS (for example 507) in the same enterprise, the use of a plurality of TPSs could create a situation in which messages between users connected to different TPSs will not be secure . . . The enterprise expects such communication to be secure (i.e., avoid passing trough the Internet and the IM service in clear text).

To provide the expected security, even in the case of multiple deployed TPSs, each TPS can be configured to establish a network connection to each of the other TPSs in the enterprise. TPSs configured to connect to each other for the purpose of exchanging information are called peers, and the established communications channel is called the peering channel.

FIG. 5 shows a dashed line 513, which is the peering channel that can be set up between the TPSs 504 and 507. In general, if an enterprise deploys N TPSs for scalability and redundancy, rather than the two shown in FIG. 5, then N×(N−1)/2 peering channels can be created, so that each TPS has one open peering channel open to each of the other TPSs.

Once peering channels are created between peered TPSs, a message can be sent between peers over the peering channels until it reaches its target. The message need not traverse the Internet nor the IM service, eventhough the sender and recipient are connected to different TPSs. Sending messages between peers via peering channels, rather than via the IM service, is called message routing.

A TPS uses the peering channel to communicate with its peers (other TPSs). The communication may include but is not limited to one or more of the following actions:

1. send user availability indications

2. query for user availability

3. send messages

To implement message routing, each peer maintains two tables of information. The first table, the peer table, simply keeps track of all the peering connections. Some messages are sent to all peers in the peer table simultaneously. These messages are called broadcast messages.

The second table, the user availability table, keeps track of the availability of users along with the peer, to which the users are attached, if any. To prevent the user availability table from growing unboundedly, its entries can expire after a period of inactivity.

There are four ways to ensure the contents of the user availability table to be correct. The first, called availability priming, has each peers broadcast the availability of each user, connected to it, as that user logs on or off. This way, each peer maintains a user availability table that knows conclusively the availability of every user that is connected to any peer. This method of maintaining the user availability table is fragile; if a single priming message is lost, then messages between two parties will be insecurely routed until one or both of the parties logs off.

Alternatively, availability discovery has the peers query the availability of users as needed and cache the results. This method of maintaining the user availability table is less fragile, but is susceptible to short-term inaccuracies. For example, if a user changes his status, having been connected directly to the IM service, and reconnects via a peer, that change will go unnoticed. In that case, messages will continue to be routed insecurely, until the session ends. That is not catastrophic, since the user was originally connected via an insecure means anyway.

A third possibility is a combination of availability priming and availability discovery. The hybrid method has the advantages of both methods. It's less fragile than priming yet can detect when a user with active sessions changes the method of connection.

A fourth possibility is to use the IM service presence notification messages instead of the peer availability priming messages. The presence messages indicate that a user has logged on or off, but otherwise convey different information than the priming messages. With the log on notification, there is no indication as to which peer a user is connected to, if any. Also the TPS will receive presence indications only for those screen names that are in the contact list for at least one directly connected user.

The latter inconvenience is mitigated by the fact that most people only communicate with users in their contact lists. It is a viable policy to insist that users talk only to other users in their contact lists, and only when those users' presence information indicates that they are online. Not only does this policy allow the IM service presence messages to be used in place of the availability priming messages, but also it closes a potential security vulnerability, as will be discussed later.

The three types of communications between TPS peers, referenced above will now be described in more detail.

The first peering action, if used, broadcasts user availability. When a user (identified by screen name) logs on or logs off, that user's availability is broadcast. When a peer receives an indication that a user logs on, the peer adds the entry to the user availability table. When a user logs off, that entry (if still there), is removed. The user might stay logged on indefinitely. The user availability entry will nonetheless expire after a relatively short period of inactivity.

The second peering action, if used, is also a broadcast. A peer needs to know if a given user is available via another peer. The TPS broadcasts the query, asking which peer has the given user connected. If a reply is received, then the user availability table is updated. If no reply is received after a certain timeout, the user availability table is updated to indicate that the user is available via the IM service. In the discussion of indirect routing, it will be explained why such indication should take the form of a distance metric of infinity.

The third peering action is to send a message. When a TPS knows that a user is connected to a peer, it can send messages addressed to that user to the peer, and the peer will deliver the messages.

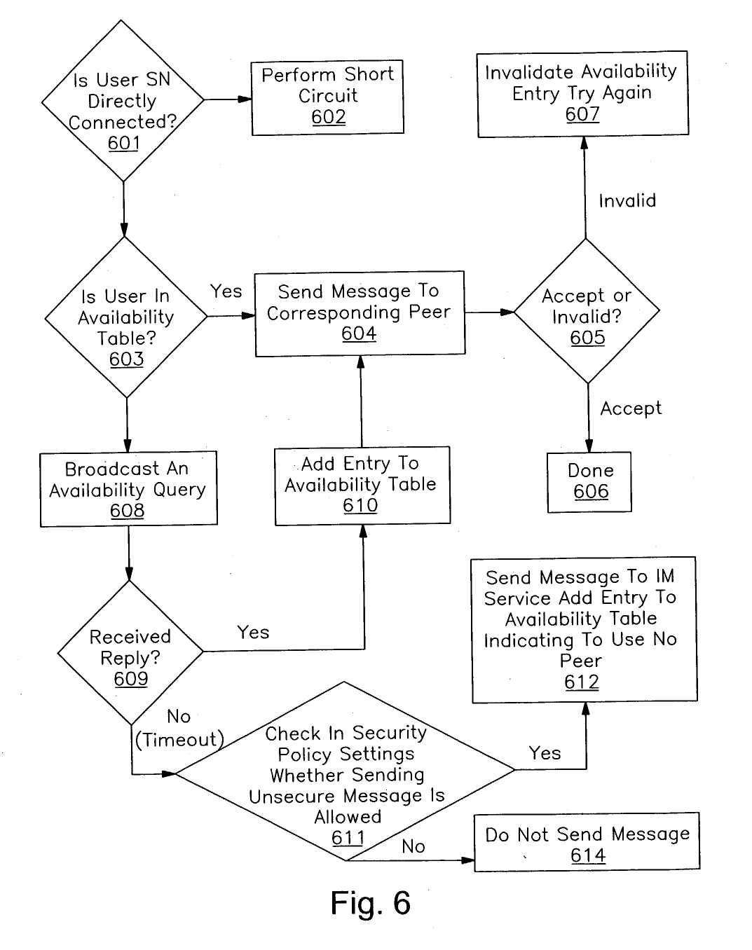

FIG. 6 illustrates the routing process. When a TPS receives a message destined for a given screen name, it first checks at step 601 to see if the user with that screen name is directly connected to that TPS. If that is the case, at step 602, the message is short circuited, as has be discussed previously. If that is not the case, the TPS, at step 603, checks the user availability table.

If an entry is found, at step 604 the TPS sends the message to the peer to which the target user is connected. The process isn't finished at this point. It is possible, at step 605, that the user has logged off (or switched peers, or logged into the IM service directly), and that the information, that the user is no longer available on this specifc peer, has not yet propagated. So the target peer might accept the message, in which case, at step 606, the process is finished. Otherwise, at step 607, the peer has returned an indication that the message routing is invalid, in which case, the entry in the user availability table is invalidated, and the TPS tries again to deliver the message.

If, at step 603, the TPS finds no entry for the target user in the user availability table, then at step 608 the TPS broadcasts an availability query. At step 609, if the TPS receives a reply from a peer, then at step 610, the user availability table is updated, and the message is sent to the corresponding peer, as per step 604.

If the step 609 availability query times out, indicating that the target user is not available via a peer, then the message must be sent to the IM service in an unsecure way. In order to control the potential security risk, the TPS consults previously defined security policy settings at step 611 to determine whether sending the message complies with the policies of the enterprise. The security policy settings may indicate that a certain user may not send any outside messages. They may also indicate that a cartain user may only send messages to users that are on his/her contact list and are online. If the security policies allow the message to be sent, the message is forwarded to the IM service for final delivery at step 612. If the security policies do not allow the message to be delivired it is not delivered, at step 614, and the sender may be alerted of the decision not to deliver the message. The security check step 611 is optional.

If the security policy check step 611 did not exist, when a user (User B) sends a message to another user in the same enterprise who is not logged in (User A), the TPS will proceed through steps 601, 603, 608, 609, and 612, to decide that the user is not available via a peer. The TPS will then send the message in clear text to the IM service, which can be a security problem.

If, however, the TPS is configured to allow User B to send messages only to users on his contact list, and only if those users are logged in, then the vulnerability is mitigated. If User A shows as present on User B's contact list, then User A must be logged in and to either a peer or not to a peer. If User A is logged into a peer, then the message transmission will be secure. If User A is logged in, but not to a peer, then policy settings in the TPS will dictate whether User B is allowed to send insecure messages. A test of those settings enables such further security protection. Thus, if User B is allowed to send unsecure messages, then the fact that User A logged in without connecting to a TPS, indicates a willingness to permit such messages to be transmitted insecurely.

This additional test eliminates a vulnerability when User A is logged off. When another employee (User B) in the enterprise tries to send a message to the logged off User A, then message could traverse the Internet and the IM service as clear text if the policy settings were not included in the TPS 109 as an additional test.

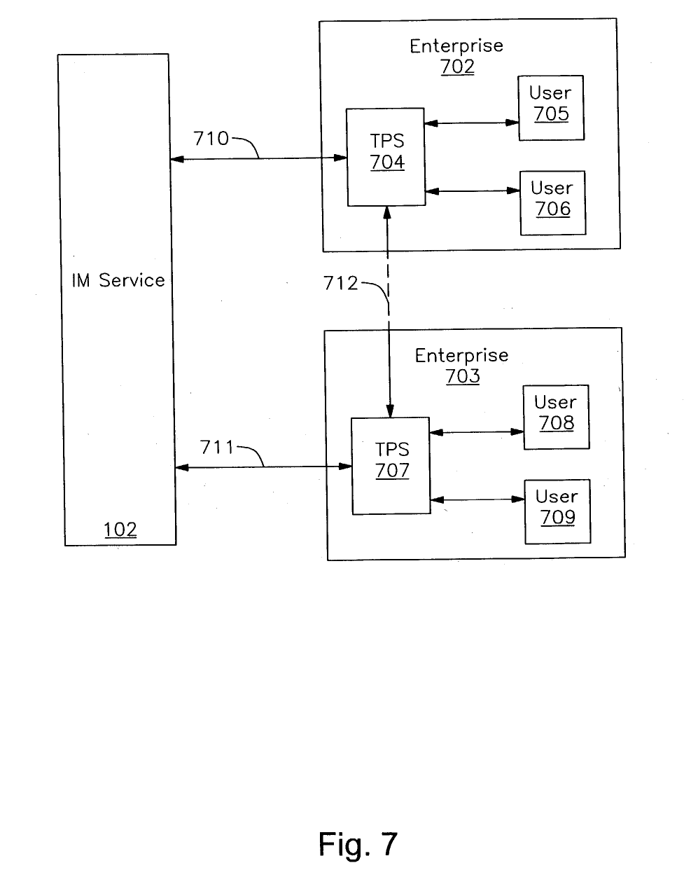

The description of peering and routing has thus far been made under the assumption of a single enterprise. Peering can also be performed between TPSs in different enterprises, as is illustrated by FIG. 7. The figure shows enterprise 702 with users 705 and 706 connected to a TPS 704. TPS 704 is connected to the IM service 102. A second enterprise 703 is present, with users 708 and 709 connected to TPS 707. TPS 707 is also connected to IM service 102. It should be noted that TPS 704 is located at and controlled by enterprise 702, while TPS 707 is located at and controlled by enterprise 703. In the absence of peering between the enterprises, messages sent between a users in these two different enterprises (say, for example between users 705 and 709) will pass through the Internet and the IM service in an insecure manner. However if the two enterprises cooperate and create a peering connection 712, then messages sent between users in these two different enterprises will pass through the Internet but will not pass through the IM service, offering an increased measure of security. Furthermore, the peering channels between TPSs at different enterprises can be encrypted. If the peering channels are encrypted, then the messages that pass through the Internet, to get from one enterprise to the other, remain secure.

FIG. 7 shows each enterprise deploying a single TPS. However, it is also possible that either or both enterprises deploy multiple TPSs for the sake of scalability and redundancy. In that case, it is necessary to create peering channels between each TPS with the enterprise, as well as between each TPS at the different enterprises. And the same connectivity can apply when there are three or more enterprises involved.

When a TPS sends a message to a directly connected peer, and that peer has the target user directly connected, the routing is called direct routing. When a TPS needs to send a message to a user that is connected to a peer, but not directly connected to the TPS, then the routing is called indirect routing. The TPS must figure out which of the several directly connected peers can best deliver the message to the target user.

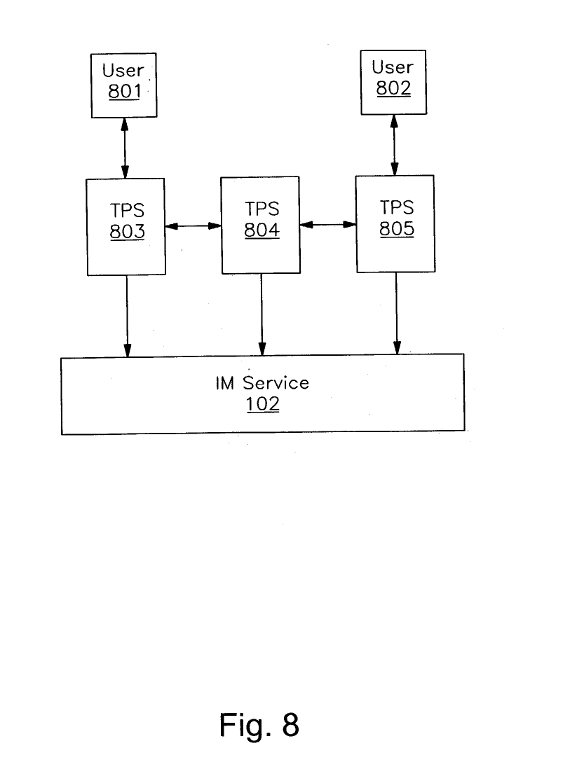

FIG. 8 illustrates a situation in which multiple TPSs are peered, but not all TPSs are directly connected to all other TPSs. TPS 803 is indirectly connected to TPS 805. A message sent from user 801 to user 802 cannot be routed directly. Instead, a computation has to be made to determine that the best route from TPS 603 to TPS 605 is via TPS 604.

If the TPS supports only direct routing, then the message from user 801 to user 802 must be sent via the IM service 102, with the security vulnerability that such routing entails. If the TPS supports indirect routing, then the message can be routed indirectly through TPS 804, and the security vulnerability is mitigated. The inderect routing capability for TPSs can be achieved using well known methods for routing IP packets, and is based on each TPS computing a distance metric from itself to each user, via each peer. The TPS picks the peer that results in the lowest distance metric to reach the user. For the sake of the indirect routing computation, the IM service 102 itself can be treated as a peer, via which the distance to each user is infinite. The IM service 102 will be selected as the best route only when no peer TPS exists with a shorter route to the user, which is the case only when the user is not connected to any (directly or indirectly connected) peer.

There are other useful features that are made possible by the use of the TPS of the present invention. A few are described below.

An IM messaging session is a collection of consecutive messages that are sent between a user and one or more other users. Some IM services define a messaging session, as starting when an IM window is created, and ending when the IM window is closed, or when a period of inactivity (e.g., 5 minutes) elapses. For some IM services the concept of session has no relevance—they treat each message as a separate unrelated event.

The TPS may define sessions independently of the IM service's definition of a session (if one exists for a given service). Initially the TPS treats all messages as independent events. The messages are then collected into sessions based on the parties to each message and the time each message was made. If there is no session when a message arrives, then a new session is created. Additional messages between the same parties are added to the session as they arrive. The session is closed when a period of inactivity elapses. It is also possible to use the IM service indication of session, when available, to open and close TPS sessions.

The TPS has the ability to make decisions about the handling of each message on a message by message basis. The capability of the TPS to route messages is a direct consequence of this ability. The same ability empowers the TPS to offer administrators substantial control over the employees' use of instant messaging within the enterprise. The administrator may indicate the level of access to instant messaging allowed for each employee, identifying each employee by their screen name. The levels of access may control, among other things, whether an employee can send messages, participate in chat sessions, and send or receive files.

As part of access control, the administrator can, for each user, specify a message to be delivered at the beginning and/or end of each messaging session. The message can be used to remind the user of the enterprise's policies regarding the use of instant messaging. For example, when an employee initiates a conversation with another instant messaging user, who doesn't happen to be connected via an enterprise TPS, the first user might receive the reminder, “You are talking to an external user. Do not disclose confidential information.”

Messages can be inserted by the TPS into a message stream between users. A problem is that on typical messaging services, the inserted message, initiated by the TPS, will appear to have come from the other user. To indicate that the message came from the TPS, the message can be prefixed with a carriage return and a string that appears as though it is a screen name of the TPS. For example, on AIM, the TPS might prepend the text “<cr>ActiveProxy:” to any message it generates. To the target user it will appear as though an empty message arrived from the other user, and then a message arrived from ActiveProxy.

The TPS stores a user profile for each user. That profile contains various data items, including the user's email address, and an indication of whether they want to receive copies of their IM sessions via email.

The user profile can be created many ways. One method is to display a web link in each session start message. The user clicks on the link, which causes the web browser to open. The user can be transparently authenticated to the web server, as is described in U.S. Pat. No. 6,430,602 assigned to the assignee of the present invention.

The TPS saves two separate logs, one for the administrator, and the other for the participants in each session. The logs are stored one session at a time. When a session closes, the logs for that session can be emailed to the user. The user controls such logging by modifying his/her user profile.

An IM service will send a message from one user to another only if both users are logged into the service. However, the TPS short circuits and routes messages, allowing users to communicate without sending the messages through an IM service. It is therefore possible to send messages between users connected to the TPS or its peers (these users are called internal users), even if the users are connected via different IM clients.

But, how does an internal user logged in via one IM service indicate that he wishes to send a message to another internal user logged in via a different service? It depends on the client IM software. The AIM client software currently allows the user to enter names in the contact list that are not necessarily legitimate AIM screen names.

The MSN and Yahoo clients check that the entered name corresponds to a legitimately registered user. That check can be subverted by the TPS in a way that allows the user to enter strings that do not correspond to valid screen names.

Given that a user can enter invalid screen names in their contact list, a special syntax can be defined, so that the user can identify which screen name and service is desired. There are many different ways to define the arbitrary syntax. The preferred syntax takes one of two forms, either SN@SERVICE or user@email.com.SERVICE, where SN is the screen name on the given service, and SERVICE is the name of the service, such as aim, msn, and yahoo.

For example, the Yahoo user can indicate an AIM user with screen name fredjones by specifying fredjones@aim.

The AIM and Yahoo IM services have recently been upgraded to allow email addresses to be used as screen names (MSN always used email addresses as screen names.) When the target screen name is an email address, the cross-service screen name is constructed by appending .aim, .msn, or .yahoo to the email address. For example marysmith@example.com on AIM is entered as marysmith@example.com.aim in both MSN and Yahoo clients.

When the TPS sees a session initiation or a message (depending on which IM service) targeting a screen name that ends with the special syntax, it creates a cross-service IM session, strips the special suffix, and sends the message.

The interoperability can be extended to send cross-service messages to external (non-internal) users. However, the user sending a cross-service message must be logged into all target IM services. For example, if a user with screen name marysmith on AIM wants to send a message to a Yahoo user, she must also be logged in on a Yahoo client, via the TPS (or a peer). Then she can send messages to Yahoo using her AIM client.

The TPS needs to know that a given set of screen names on various services correspond to the same user. The user updates the user profile for each screen name on each service, listing their screen names on the other services. If the TPS finds that A has B listed as a cross-service alias, and also that B has A listed as a cross-service alias, then the TPS can be confident that A and B are in fact cross-service aliases. In order to set up a symmetric indication, the user needs access to both user profiles. That is only possible if the user controls both screen names.

For example, marysmith@aim and maryksmith@yahoo are the same user. She logs in using both the AIM and Yahoo clients. Mary then modifies her user profile for marysmith@aim, indicating that maryksmith@yahoo is a cross-service alias. She also modifies the user profile for maryksmith@yahoo, indicating that marysmith@aim is a cross-service alias. Then she adds markjones@yahoo to her AIM contact list. She double clicks on that entry and sends a message.

The TPS sees a message from marysmith@aim, intended for maryksmith@yahoo. Because of the special syntax, the TPS knows that it must initiate a cross-service IM session. It looks in the user profile for marysmith@aim and finds maryksmith@yahoo as an appropriate alias. It then checks in the profile for maryksmith@yahoo to make sure that marysmith@aim is listed. The TPS then sends a message from maryksmith@yahoo to the target.

As has been described, interoperability allows the user to engage in IM conversations across a plurality of IM services while using only one prefered NM client. However it is necessary that the user be logged in to each of the IM services with which he would like to exchange messages. This limitation can be removed by having the TPS log in to the secondary IM services on behalf of the user.

As has already been described, the user profile for a given screen name specifies cross-service aliases for the same user. Additionally, the user profile can store passwords for those same cross-service aliases. When a user logs in to a primary account via the TPS, the TPS then logs in on behalf of that user to all cross-service aliases for which passwords are provided. Thus, the user need only log in to their primary IM service, and the TPS will log in as a virtual client to the secondary IM services using the cross-service aliases.

One special case occurs when a user has the same account and password on a plurality of IM services. This case may occur in an enterprise that uses the federated authentication mechanism now being offered by IM servcies. In the case that the enterprise controls the screen names, the TPS can be configured to log in to all secondary IM services automatically even when there is no user profile indication to do so.

The TPS can map screen names to user friendly names, the user-friendly names having been defined either by the enterprise or a user. IM screen names are often obtuse, due to the limited address space that must be shared by all users. The TPS can translate screen names to friendly names for the benefit of the user and then back to screen names for the benefit of the IM service.

The IM services constantly upgrade their client IM software. When an upgrade is available, the IM service notifies the running IM client that an upgrade is available, which in turn notifies the user.

There are many reasons that an enterprise might want to control which version(s) of the client IM software a user runs, including but not limited to: earlier versions might not provide a minimum feature set; enterprises like to test network software for compatibility and vulnerabilities before deployment; some versions of network software have known vulnerabilities or bugs; the TPS itself might be incompatible with upgrades.

The TPS can be configured by the administrator to prevent it from running versions of the client IM software other than those specified. It can also be configured to block some or all upgrade notices, in order to discourage users from upgrading to versions, that are not wanted by the enterprise.

Computers and machines referred to in this application, may include but are not limited to be workstations, or other computing devices, such as terminals, Personal Digital Assistants, and sophisticated cell phones. The enterprise network may be virtual as well as physical.

While an illustrative embodiment of the invention has been described, various modifications will be apparent to those of ordinary skill in the art. Such modifications are within the spirit and scope of our invention, which is limited and defined only by the appended claims.

We claim:

1. A method for directing an instant message to an end-user using an instant messaging protocol, comprising the steps of:
providing a proxy server on a local network;
receiving at the proxy server the instant message sent from a first end-user connected to the local network to a second end-user, the instant message being associated with an instant messaging service supported by a back-end instant messaging server;
determining at the proxy server whether the second end-user is connected to the local network; and
in the event that the second end-user is connected to the local network, directing the instant message to the second end-user solely within the local network while bypassing the remote network and the back-end instant messaging server.

2. The method of claim 1, including the further step, in the event that the second user is not connected to the local network, of forwarding the instant message to the second end-user by way of the back-end instant messaging server.

3. The method of claim 1, wherein the receiving step receives the instant message from an end-user instant messaging software application.

4. The method of claim 3, wherein the receiving step is performed transparently to the end-user instant messaging software application.

5. The method of claim 3, wherein the directing step is performed transparently to the end-user instant messaging software application.

6. The method of claim 4, wherein the directing step is performed transparently to the end-user instant messaging software application.

7. The method of claim 2, wherein the receiving step receives the instant message from an end-user instant messaging software application.

8. The method of claim 7, wherein the receiving step is performed transparently to the instant messaging software application.

9. The method of claim 7, wherein the forwarding step is performed transparently to the instant messaging software application.

10. The method of claim 8, wherein the forwarding step is performed transparently to the instant messaging software application.

11. The method of claim 1 wherein the proxy server is a software application.

12. A method for providing enhanced instant messaging functionality to an end-user using an instant messaging software application that is implemented on a client computer, the instant messaging software application being configured to connect to a back-end instant messaging server, comprising the steps of:
providing a proxy server;
creating a first network connection between the instant messaging software application and the proxy server;
whereby the instant messaging software application is caused to connect to the proxy server in a manner that does not require changes to the client software configuration nor the client computer configuration;
creating a second network connection between the proxy server and the back-end instant messaging server; and
selectively directing messages between the instant messaging software application and the back-end instant messaging server trough the proxy server by way of the first network connection and the second network connection.

13. The method of claim 12, wherein the proxy server is a software application.

14. The method of claim 12, wherein the proxy server has a first port connected to the first network connection which is configured to emulate the communication interface of the back-end instant messaging server;

15. The method of claim 12, wherein the proxy server is transparent to the back-end instant messaging server.

16. The method of claim 15, wherein the proxy server has a second port connected to the second network connection which is configured to emulate the communication interface of the instant messaging software application.
